(19) United States
(12) Patent Application Publication
(10) Pub. No.: US 2026/0211974 A1
(43) Pub. Date: Jul. 23, 2026

(54) COMPUTING DEVICE AND COMPUTING METHOD

(71) Applicant: Preferred Networks, Inc., Tokyo (JP)

(72) Inventors: Junichiro MAKINO, Tokyo (JP); Ken NAMURA, Tokyo (JP); Tomoya ADACHI, Tokyo (JP); Takuya YAMAUCHI, Tokyo (JP)

(21) Appl. No.: 19/358,723

(22) Filed: Oct. 15, 2025

Related U.S. Application Data
(60) Provisional application No. 63/708,298, filed on Oct. 17, 2024.

(30) Foreign Application Priority Data
Jun. 27, 2025 (JP) 2025-109720

(51) Int. Cl. G06F 17/16; G06F 7/53

(52) U.S. Cl. CPC G06F 17/16; G06F 7/5318

(57) ABSTRACT

A computing device includes one or more register files configured to store a first matrix and a second matrix; one or more conversion circuits configured to convert a value of the first matrix or the second matrix read from the one or more register files so that the value corresponds to a plurality of values; and one or more multiplication circuits configured to calculate a product of the first matrix and the second matrix, using a result of the converting of the one or more conversion circuits.

### CROSS-REFERENCE TO RELATED APPLICATIONS

This patent application is based on and claims priority to U.S. Provisional Application No. 63/708,298, filed Oct. 17, 2024, and Japanese Patent Application No. 2025-109720, filed Jun. 27, 2025, the entire contents of which are incorporated herein by reference.

### TECHNICAL FIELD

The present disclosure relates to a computing device and a computing method.

### BACKGROUND

Computing devices configured to perform matrix operations are known.

### RELATED ART DOCUMENT

### Patent Document

[Patent Document 1] Japanese Laid-open Patent Application Publication No. 2018-194905

### SUMMARY

A computing device according to an embodiment of the present disclosure includes one or more register files configured to store a first matrix and a second matrix; one or more conversion circuits configured to convert a value of the first matrix or the second matrix read from the one or more register files so that the value corresponds to a plurality of values; and one or more multiplication circuits configured to calculate a product of the first matrix and the second matrix, using a result of the converting of the one or more conversion circuits.

### BRIEF DESCRIPTION OF THE DRAWINGS

FIG. 1 is an exploded perspective view illustrating an example of a configuration of a computing device;

FIG. 2 is a plan view illustrating an example of a configuration of a logic die;

FIG. 3 is a block diagram illustrating a first example of a configuration of a matrix arithmetic block;

FIG. 4 is a block diagram illustrating a second example of the configuration of the matrix arithmetic block;

FIG. 5 is a block diagram illustrating a third example of the configuration of the matrix arithmetic block;

FIG. 6 is a block diagram illustrating an example of an operation sequence of the matrix arithmetic block; and

FIG. 7 is a block diagram illustrating an example of a hardware configuration of a computer in which the above-described computing device is mounted.

### DETAILED DESCRIPTION

Hereinafter, embodiments of the present disclosure will be described with reference to the accompanying drawings. Here, in the present specification and the drawings, components having substantially the same functional configuration are denoted by the same reference numerals and duplicated descriptions thereof will be omitted.

Here, in the present specification (including the claims), the terms “first”, “second”, and the like are used merely as a way of distinguishing between two or more elements, and are not necessarily intended to impose a technical meaning such as a temporal aspect, a spatial aspect, an order, a quantity, or the like on the object. Thus, for example, reference to the first element and the second element does not necessarily indicate that only two elements may be employed therein, that the first element must precede the second element, or that the first element must exist in order for the second element to exist.

One embodiment of the disclosure may be an example of a computing device configured to perform a predetermined operation. The computing device may include any arithmetic unit configured to perform any operation. The computing device may be connected to another processor. The other processor may include a central processing unit (CPU) or a graphics processing unit (GPU). The computing device 100 may function as a computer configured to perform any operation.

The computing device may function as an accelerator configured to perform an operation on a machine learning model, for example. The operation on the machine learning model may include an operation to perform a training process or an operation to perform an inference process, for example. The machine learning model may include a neural network, a generative model, an underlying model, a large language model (LLM), a vision language model (VSL), a space state model (SSM), or the like, for example.

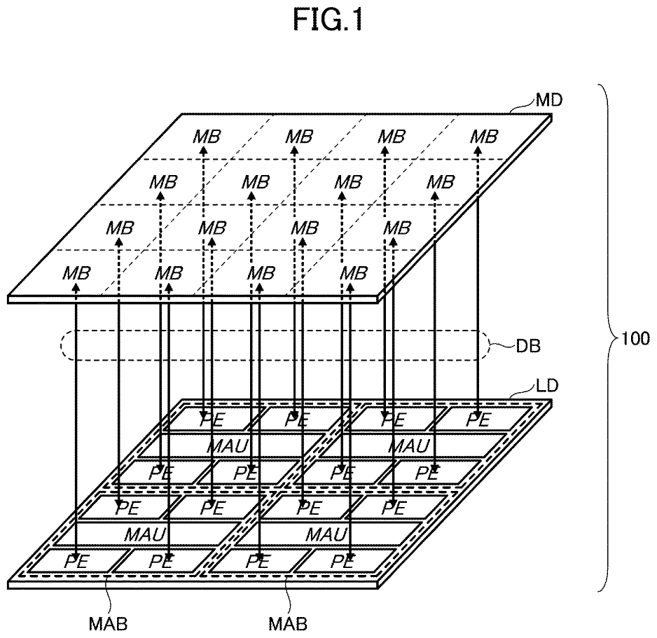

FIG. 1 is an exploded perspective view illustrating an example of a configuration of a computing device. As illustrated in FIG. 1, the computing device 100 may include a three-dimensionally integrated logic die LD and a memory die MD.

The logic die LD may include a plurality of processing elements PE operable in parallel. The logic die LD may be connected to one or more memory dies MD. The logic die LD and the memory die MD may be stacked and connected to each other via a data bus DB.

A control signal line, which is not illustrated, used for reading and writing data may be connected between the logic die LD and the memory die MD. Additionally, “stacked” in “stacked die” and the like includes a case where the die is arranged above, below, or both above and below another die. For example, a memory block MB included in the memory die MD may be arranged above, below, or both above and below a matrix arithmetic block MAB and the processing element PE included in the logic die LD. Additionally, an element other than the die may be inserted between the plurality of dies to be stacked to the extent that wideband data transfer can be maintained.

When the logic die LD and the memory die MD are stacked, the distance between the dies can be made smaller than the thickness of the die. Therefore, for example, in comparison with the case where the logic die LD and the memory die MD are arranged side by side on the same substrate, the load capacity of the data bus DB can be greatly reduced, and the propagation delay time of a data signal or the like transmitted to the data bus DB can be greatly shortened. As a result, the arithmetic processing performance of the chip CP can be improved.

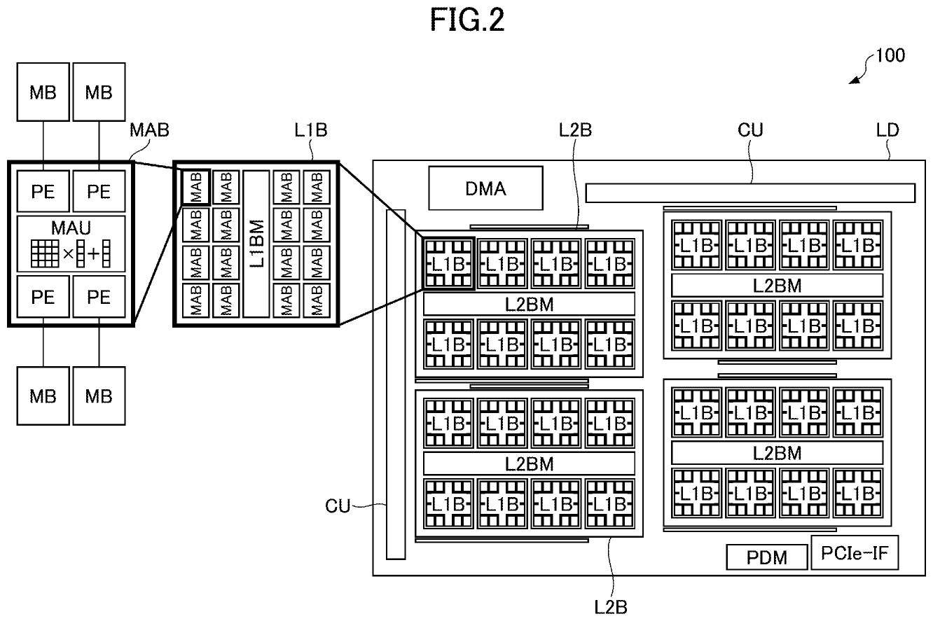

The memory die MD may include a plurality of memory blocks MB respectively arranged opposite to the processing elements PE. Each of the plurality of memory blocks MB may be used exclusively for the opposing processing elements PE. Although FIG. 2 illustrates an example in which the memory die MD is connected to the plurality of processing elements PE, the plurality of memory dies MD may be respectively arranged opposite to the plurality of processing elements PE and connected to the opposing processing elements PE. That is, the memory die MD and the processing elements PE may be connected in a ratio of 1:m (m is an integer greater than or equal to 1) or in a ratio of 1:1. Each of the plurality of memory blocks MB included in one or more memory dies MD may be used as a scratch pad memory for a processing element PE connected to itself.

The memory die MD may include any number of memory blocks MB. The number of memory dies MD connected to the logic die LD may be determined in accordance with the number of memory blocks MB included in each of the memory dies MD. The logic die LD may include one or more matrix arithmetic blocks MAB. Each of the one or more matrix arithmetic blocks MAB may include one or more processing elements PE and a matrix arithmetic unit MAU.

For example, the memory die MD may be a dynamic random access memory (DRAM), a static random access memory (SRAM), a magnetoresistive random access memory (MRAM), a phase-change RAM (PRAM), a flash memory, or the like. The memory die MD may include one or more DRAMs, one or more MRAMs, one or more PRAMs, one or more flash memories, and the like.

By three-dimensionally integrating the logic die LD and the memory die MD, the length of the data bus DB and the control signal line can be made equal to or less than the thickness of the die. Accordingly, the wiring capacitance and the wiring delay can be minimized, and the increase of the charge/discharge current of the data bus DB and the control signal line can be suppressed.

The memory block MB and the memory die MD may be used as a work memory of the processing element PE. By using the work memory provided outside the logic die LD, the storage capacity of the work memory can be greatly increased in comparison with the case where only the work memory inside the logic die LD is used. Accordingly, the computing device 100 having a large capacity and a large bandwidth can be realized, and an application having a high frequency of memory access can be efficiently executed. As a result, the computing device 100 can perform a training process of a machine learning model, an inference process, a scientific technology calculation, or the like, which requires a large amount of data processing, at a high speed and low power.

Here, FIG. 1 illustrates an example in which arithmetic units, such as the processing element PE, the matrix arithmetic unit MAU, or the matrix arithmetic block MAB, and the memory block MB are formed on different dies. However, the arithmetic units and the memory block MB may be formed on different layers of a single die, and the layer of the computing device and the layer of the memory block MB may be connected to each other through a via such as a through silicon via (TSV).

FIG. 2 is a plan view illustrating an example of a configuration of the logic die. The logic die LD may include one or more blocks L2B, a data transfer circuit DMA, a communication unit CU, a peripheral component interconnect express interface (PCIe-IF), and a memory PDM.

The block L2B may include one or more blocks LIB and a memory L2BM. The block LIB may include one or more matrix arithmetic blocks MAB and a memory L1BM. The matrix arithmetic block MAB may include one or more processing elements PE and a matrix arithmetic unit MAU. The storage capacity of the memory L2BM may be larger than that of the memory L1BM. The storage capacity of the memory block MB may be larger than that of the memory L1BM.

The processing element PE may be connected to the memory block MB. The plurality of processing elements PE may be respectively connected to the plurality of memory blocks MB. At least a part of the data stored in the memory block MB may be used in the matrix arithmetic unit MAU without using the memory L1BM. Here, the matrix arithmetic unit MAU may be formed by a systolic array.

The logic die LD may include hierarchical blocks LIB and L2B including a predetermined number of matrix arithmetic blocks MAB. The memory L1BM and the memory L2BM may have a hierarchical structure. All the matrix arithmetic blocks MAB mounted on the logic die LD may operate by the same instruction.

Here, the number of elements included in the logic die LD need not be limited to the configuration illustrated in FIG. 2. For example, the logic die LD may include one block L2B or a plurality of blocks L2B.

As one example, the logic die LD may include two blocks L2B. Each of the blocks L2B may include four blocks LIB and one memory L2BM. Each of the blocks LIB may include 16 matrix arithmetic blocks MAB and one memory L1BM. Each of the matrix arithmetic blocks MAB may include eight processing elements PE and one matrix arithmetic unit MAU.

As another example, the logic die LD may include four blocks L2B. Each of the blocks L2B may include eight blocks LIB and one memory L2BM. Each of the blocks LIB may include 16 matrix arithmetic blocks MAB and one memory L1BM. Each of the matrix arithmetic blocks MAB may include four processing elements PE and one matrix arithmetic unit MAU. The matrix arithmetic block MAB need not include a matrix arithmetic unit MAU.

A large number of matrix arithmetic units MAU are distributed and arranged in the logic die LD. By connecting the memory block MB having a large capacity and a large bandwidth to each of the processing elements PE, the logic die LD can supply data to each of the distributed matrix arithmetic units MAU without waiting for operation. That is, this can suppress degradation of the calculation speed resulting from a period during the matrix arithmetic unit MAU is unable to execute an operation because the memory bandwidth is not sufficient. Here, one or both of the matrix arithmetic units MAU and the processing elements PE are examples of the arithmetic unit. Additionally, the arithmetic unit may be any of an arithmetic circuit, a processing circuit, or processing circuitry.

Here, it is preferable that the number of blocks L2B mounted on the logic die LD, the number of blocks LIB mounted on each of the blocks L2B, the number of matrix arithmetic blocks MAB mounted on each of the blocks LIB, and the number of processing elements PE mounted on each of the matrix arithmetic blocks MAB are the n-th power of 2 (n is an integer greater than or equal to 1).

The data transfer circuit DMA may be an example of a processing circuit configured to control data transfer within the computing device 100. The data transfer circuit DMA may control the transfer of data, stored in the memory PDM from the outside of the logic die LD, to the memory L2BM or the memory L1BM, or may control the transfer of data between the memory L2BM, the memory L1BM and the matrix arithmetic block MAB. The data transfer circuit DMA may be a direct memory access controller (DMA controller), for example. Here, the computing device 100 may include a processing circuit configured to control data transfer between the memory L2BM, the memory L1BM and the matrix arithmetic block MAB, and the data transfer circuit DMA may be configured to control only data transfer between the memory PDM and the memory L2BM.

The communication unit CU may be an example of a processing circuit configured to control the connection between the computing device 100 and another computing device 100. The communication unit CU may include a communication circuit specialized in data transfer for executing a predetermined operation. The predetermined operation may include, for example, a matrix operation. The matrix operation may include a product of a matrix and a matrix or a product of a matrix and a vector. The predetermined operation may include at least one of broadcasting, contraction, or transfer performed in a matrix operation.

The logic die LD may include a plurality of communication units CU. The logic die LD may include a plurality of communication units CU respectively corresponding to the computing devices 100 to be connected. The logic die LD may include a plurality of communication units CU specialized in different operations. For example, the logic die LD may include a communication unit CU specialized in broadcasting and a communication unit CU specialized in contraction.

The PCIe-IF may transmit and receive data, instructions, and the like with a host or a device externally connected to the computing device 100. The memory PDM may function as a buffer memory for holding data and the like transmitted and received via the PCIe-IF. For example, the PCIe-IF may be implemented by a field programmable gate array (FPGA).

Each of the processing elements PE may be connected to the memory block MB of the memory die MD. Each of the processing elements PE need not be directly accessible to any memory block other than the memory block MB directly connected thereto. Each of the processing elements PE may be programmed to operate without using an operation result of another processing element PE.

The matrix arithmetic unit MAU may execute single instruction multiple data (SIMD) instructions. Here, the computing device 100 may have an architecture of a SIMD model in which all the matrix arithmetic blocks MAB included in the computing device 100 are operated by a single instruction.

The computing device 100 respectively connects the plurality of processing elements PE of the logic die LD to the plurality of memory dies MD or the plurality of memory blocks MB arranged opposite to the logic die LD, and three-dimensionally integrates them, so that a larger memory bandwidth can be achieved at a lower power compared to previous methods. A large memory bandwidth can be used at a lower power and cost, and thus applications requiring relatively large memory accesses, such as a training process of a machine learning model, an inference process, a scientific technology calculation, or the like, can be efficiently executed at a lower power.

For example, the computing device 100 can set the bandwidth between the logic die LD and the memory die MD to, for example, several tens of TG/s. This is sufficiently larger than the bandwidth of the HBM2 (256 GB/s) and the bandwidth of the HBM3 (819 GB/s).

In the present embodiment, the matrix arithmetic unit MAU may execute a matrix operation. For example, the matrix operation may include a matrix-matrix product, a matrix-vector product, or a tensor product. For example, the matrix operation may be an inner-product based matrix operation or a systolic-array based matrix operation.

In the present embodiment, the matrix arithmetic unit MAU may calculate a matrix-matrix product of a matrix with four rows and four columns and a matrix with one column and four rows (in other words, the matrix-vector product of a matrix with four rows and four columns and a vector of four elements), for example. Here, the matrix includes a matrix with n rows and m columns (where n and m are integers greater than or equal to 2), a vector with one row and n columns (n is an integer greater than or equal to 2), and a vector with n rows and one column (n is an integer greater than or equal to 2). For example, the matrix arithmetic unit MAU may calculate the product of a matrix A and a vector B by the matrix-vector product indicated in Equation (1). Here, the matrix A is an example of a first matrix, and the vector B is an example of a second matrix.

$$\begin{matrix}[ Ex . 1 ] & \\ ( \begin{matrix}a 00 & a 01 & a 02 & a 03 \\ a 10 & a 11 & a 12 & a 13 \\ a 20 & a 21 & a 22 & a 23 \\ a 30 & a 31 & a 32 & a 33\end{matrix} ) \times ( \begin{matrix}b 0 \\ b 1 \\ b 2 \\ b 3\end{matrix} ) = ( \begin{matrix}c 0 \\ c 1 \\ c 2 \\ c 3\end{matrix} ) & ( 1 )\end{matrix}$$

Specifically, the matrix arithmetic unit MAU includes four multipliers configured to respectively calculate the inner products indicated in Equations (2) to (5).

$$\begin{matrix}[ Ex . 2 ] & \\ c 0 = a 00 * b 0 + a 01 * b 1 + a 02 * b 2 + a 03 * b 3 & ( 2 )\end{matrix}$$

$$c 1 = a 10 * b 0 + a 11 * b 1 + a 12 * b 2 + a 13 * b 3 \qquad ( 3 )$$

$$c 2 = a 20 * b 0 + a 21 * b 1 + a 22 * b 2 + a 23 * b 3 \qquad ( 4 )$$

$$c 3 = a 30 * b 0 + a 31 * b 1 + a 32 * b 2 + a 33 * b 3 \qquad ( 5 )$$

In the related art, there is a technique for replacing the adding circuit of the multiplier with an encoder and a selection circuit (selector or multiplexer). This kind of technique includes, for example, booth coding and the like. However, this kind of technique is aimed at a single general-purpose multiplier. Therefore, if this kind of technique is directly applied to a multiplier aimed at the matrix operation, a large number of encoders and selection circuits are required, and there is a problem in terms of circuit scale or delay. For example, to realize the matrix-vector product indicated in Equation (1), 16 multipliers are required, and encoders and selection circuits are required for all 16 multipliers.

For example, a computing device using an encoder with 2-bit encoding will be described. Here, the encoder is also referred to as a conversion circuit or a converter, and encoding is also referred to as conversion. Here, multiplication of a value a and a value b is considered. In this case, first, the value a is divided into 2 bits from the least significant bit. The computing device determines multiplication results of values x and the value b, where x is the divided 2-bit value, and calculates candidates for partial products in the multiplication of the value a and the value b. The multiplication result is obtained by using a Wallace tree or the like for the partial products to add the partial products. For example, the multiplication result x*b of the value x and the value b can be determined as follows.

$$If x = 0 , x * b = 0$$

$$If x = 1 , x * b = b$$

$$If x = 2 , x * b = 2 b$$

$$If x = 1 , x * b = 3 b$$

Here, the partial product may be shifted to the left by two bits for each x, so that the digits are aligned and the addition is performed.

Therefore, if an encoder configured to pre-calculate 0, b, 2b, and 3b from the value b and a selection circuit configured to select 0, b, 2b or 3b in accordance with the value of x are prepared, a result equivalent to a two-input multiplier can be obtained. Here, 0 is a fixed value and b is the input value itself, and thus the pre-calculation is unnecessary. Additionally, 2b is a value obtained by logically left-shifting b by one bit, and thus it can be implemented only by wiring. Therefore, only 3b needs to be calculated in the pre-calculation.

The matrix arithmetic unit MAU may repeat the calculation of the matrix product. For example, in the operation related to the machine learning model, updating input data by multiplying the input data by the model parameter may be repeatedly performed. In this case, the same or different model parameters may be used in the repetition of the matrix product. Here, the model parameter may be an example of the matrix A. Additionally, the input data may be an example of the vector B. When the same matrix A is repeatedly multiplied by the vector B, if the matrix A is encoded in advance, it is unnecessary to encode the matrix A each time the multiplication is performed, and the delay caused by the encoding can be reduced.

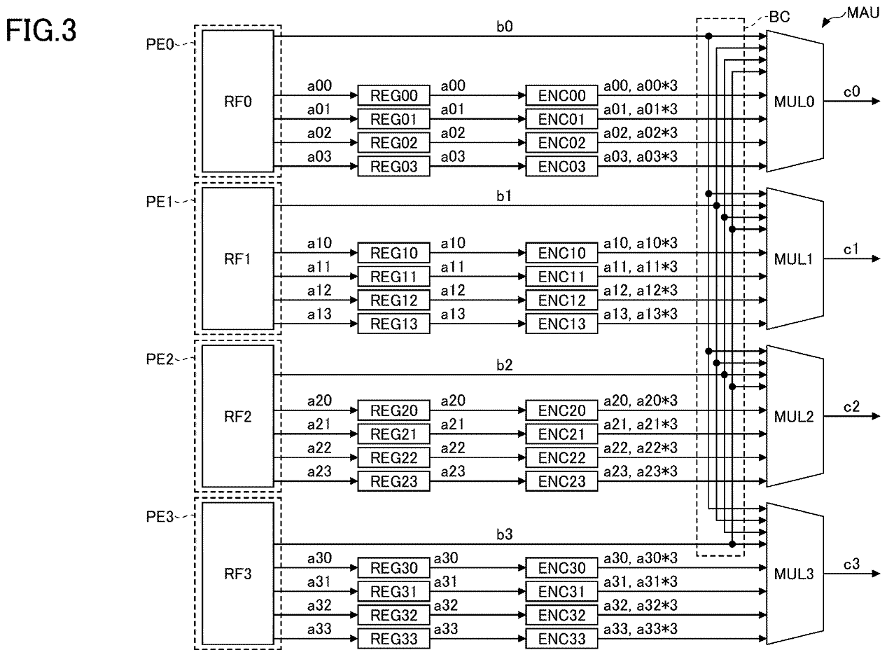

FIG. 3 is a block diagram illustrating a first example of a configuration of the matrix arithmetic unit. As illustrated in FIG. 3, the matrix arithmetic unit MAU according to the present embodiment may include 16 matrix registers REG (REG00 to REG33), 16 encoding circuits ENC (ENC00 to ENC33), a broadcast circuit BC, and four multiplication circuits MUL (MUL0 to MUL3). Additionally, the matrix arithmetic block MAB according to the present embodiment may include four processing elements PE (PE0 to PE3). The processing elements PE (PE0 to PE3) may include register files RF (RF0 to RF3). Here, the register file is also referred to as a memory.

At least a part of the matrix A and at least a part of the vector B may be stored in the register file RF. At least the part of the matrix A may be, for example, a row vector of the matrix A. At least the part of the vector B may be, for example, an element of the vector B. For example, in the register file RF0, the row vector a0=(a00, a01, a02, a03) of the matrix A and the element b0 of the vector B may be stored. In the register file RF1, a row vector a1=(a10, a11, a12, a13) of the matrix A and the element b1 of the vector B may be stored. In the register file RF2, a row vector a2=(a20, a21, a22, a23) of the matrix A and an element b2 of the vector B may be stored. In the register file RF3, a row vector a3=(a30, a31, a32, a33) of the matrix A and an element b3 of the vector B may be stored.

The matrix register REG may store at least a part (for example, a row vector or a column vector) of the matrix A read from the register file RF. The matrix register REG may be formed by one or more flip-flop circuits, for example. For example, the matrix registers REG00 to REG03 may store elements a00 to a03 of the row vector a0 read from the register file RF0. Similarly, the matrix registers REG10 to REG33 may store elements a10 to a33 of the row vectors a1 to a3.

The matrix register REG may store at least a part of the matrix A (for example, a row vector or a column vector) only when the matrix A stored in the register file RF is updated. For example, the matrix register REG00 may update the value a00 of the matrix register REG00 with the element a00 of the row vector a0 read from the register file RF0 when the element a00 of the row vector a0 read from the register file RF0 is different from the value a00 of the matrix register REG00. The matrix register REG00 need not update the value a00 of the matrix register REG00 when the element a00 of the row vector a0 read from the register file RF0 is equal to the value a00 of the matrix register REG00.

The encoding circuit ENC may encode at least a part (for example, a row vector or a column vector) of the matrix A read from the matrix register REG. For example, the encoding circuits ENC00 to ENC03 may calculate tripled values a00*3 to a03*3, which are three times the values a00 to a03 read from the matrix registers REG00 to REG03. Additionally, the encoding circuits ENC00 to ENC03 may generate doubled values a00*2 to a03*2, which are twice the values a00 to a03, by logically left-shifting the values a00 to a03 read from the matrix registers REG00 to REG03 by one bit. The encoding circuits ENC00 to ENC03 may input the encoding results (0, a00, a00*2, a00*3) to (0, a03, a03*2, a03*3) of the values a00 to a03 into the multiplication circuit MUL0. The encoding of the values a00 to a03 and the input to the multiplication circuit MUL0 may be performed in parallel or in series. The same applies to the encoding of the values a10 to a33.

Similarly, the encoding circuits ENC10 to ENC33 may input the encoding results (0, a10, a10*2, a10*3) to (0, a33, a33*2, a33*3) into the multiplication circuits MUL1-3, using the values a10 to a33 read from the matrix registers REG10 to REG33.

The broadcast circuit BC may broadcast at least a part (for example, one element) of the vector B read from the register file RF to the four multiplication circuits MUL0 to MUL3. For example, the broadcast circuit BC may broadcast the elements b0 to b3 of the vector B read from the register files RF0 to RF3 to the four multiplication circuits MUL0 to MUL3.

The multiplication circuit MUL may calculate a product of at least a part (for example, a row vector or a column vector) of the matrix A and at least a part (for example, one element) of the vector B based on the encoding results of the encoding circuits ENC and the output of the broadcast circuit BC. For example, the multiplication circuit MUL0 may calculate an inner product c0 of the row vector a0 and the vector B, using the encoding results (0, a00, a00*2, a00*3) to (0, a03, a03*2, a03*3) output from the encoding circuits ENC00 to ENC03 and the values b0 to b3 output from the broadcast circuit BC as inputs. The multiplication circuit MUL0 may output the inner product c0. The inner product c0 output from the multiplication circuit MUL0 may be stored in the register file RF0.

The multiplication circuit MUL may be, for example, a multiplexer having four inputs and one output. For example, the multiplication circuit MUL may use the encoding result (0, a00, a00*2, a00*3) by the encoding circuit ENC00 as an input and the values b0 to b3 output by the broadcast circuit BC as a control input. The multiplication circuit MUL may select one of the encoding result 0, the encoding result a00, the encoding result a00*2, or the encoding result a00*3 in accordance with the values b0 to b3 to obtain the multiplication result of the multiplication included in the inner product c0.

The multiplication circuit MUL may be a multiplexer having two inputs and one output, as another example. For example, the multiplication circuit MUL may use the encoding result (a00, a00*3) by the encoding circuit ENC00 as an input and the values b0 to b3 output by the broadcast circuit BC as a control input. The multiplication circuit MUL may include a circuit configured to generate a doubled value a00*2 by logically left-shifting the value a00 by one bit. Additionally, the multiplication circuit MUL may also include a circuit configured to generate a value 0. The multiplication circuit MUL may obtain the multiplication result of multiplication included in the inner product c0 by outputting any of the encoding result 0, a00, a00*2, or a00*3 in accordance with the values b0 to b3.

Similarly, the multiplication circuits MUL1 to MUL3 may use the encoding results (0, a10, a10*2, a10*3) to (0, a33, a33*2, a33*3) output by the encoding circuits ENC10 to ENC33 and the values b0 to b3 output by the broadcast circuit BC as inputs to calculate the inner products c1 to c3 of the row vectors a1 to a3 and the vector B. The multiplication circuits MUL1 to MUL3 may output the inner products c0 to c3. The inner products c0 to c3 output from the multiplication circuits MUL1 to MUL3 may be stored in the register files RF1 to RF3.

By storing the matrix A in the matrix register REG, the matrix arithmetic unit MAU illustrated in FIG. 3 can reduce the number of encoding operations when repeatedly calculating the product of the matrix A and the vector B. Therefore, the matrix arithmetic unit MAU illustrated in FIG. 3 can provide the computing device 100 that can perform matrix operations at high speed while reducing power consumption.

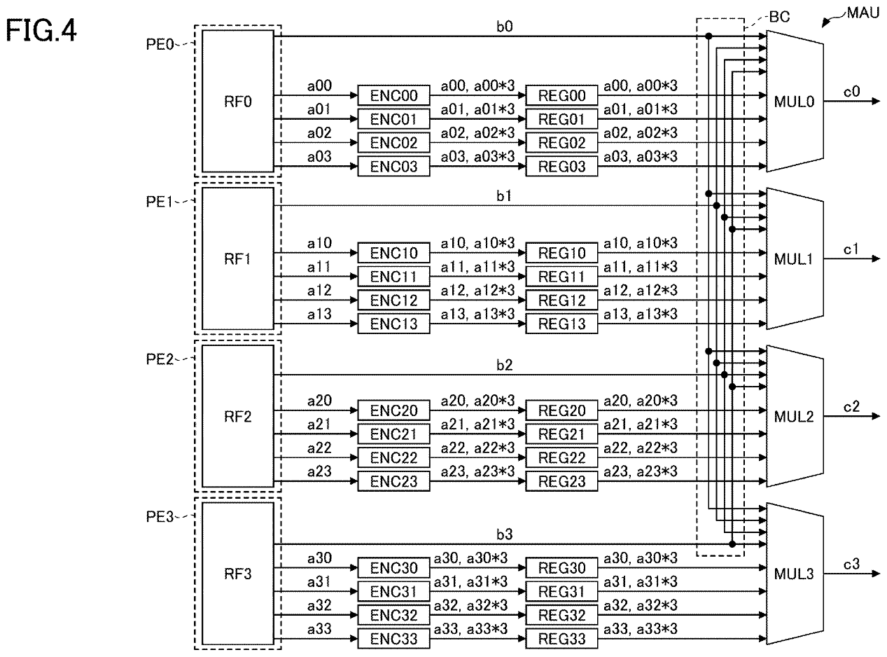

FIG. 4 is a block diagram illustrating a second example of the configuration of the matrix arithmetic unit. As illustrated in FIG. 4, the matrix arithmetic unit MAU according to the present embodiment may include 16 matrix registers REG (REG00 to REG33), 16 encoding circuits ENC (ENC00 to ENC33), a broadcast circuit BC, and four multiplication circuits MUL (MUL0 to MUL3).

Hereinafter, the configuration of the matrix arithmetic unit MAU illustrated in FIG. 4 will be described focusing on differences from the matrix arithmetic unit MAU illustrated in FIG. 3. Unless otherwise specified, the matrix arithmetic unit MAU illustrated in FIG. 4 may be configured in substantially the same manner as the matrix arithmetic unit MAU illustrated in FIG. 3.

The encoding circuits ENC may encode at least a part (for example, a row vector) of the matrix A read from the register file RF. For example, the encoding circuits ENC00 to ENC03 may calculate tripled values a00*3 to a03*3, which are three times the values a00 to a03 read from the register file RF0. Additionally, the encoding circuits ENC00 to ENC03 may generate doubled values a00*2 to a03*2 by logically left-shifting the values a00 to a03 read from the register file RF0 by one bit. The encoding circuits ENC00 to ENC03 may store the encoding results (0, a00, a00*2, a00*3) to (0, a03, a03*2, a03*3) of the values a00 to a03 in the matrix registers REG01 to REG03.

Similarly, the encoding circuits ENC10 to ENC33 may store the encoding results (0, a10, a10*2, a10*3) to (0, a33, a33*2, a33*3) in the matrix registers REG10 to REG33 by using the values a10 to a33 read from the register files RF0 to RF3.

The encoding circuit ENC may encode at least a part (for example, a row vector) of the matrix A only when the matrix A stored in the register file RF is updated. For example, when the element a00 of the row vector a0 read from the register file RF0 is different from the value a00 of the matrix register REG00, the encoding circuit ENC00 may calculate the tripled value a00*3, which is three times the element a00 of the row vector a0 read from the register file RF0, and update the encoding result (0, a00, a00*2, a00*3) stored in the matrix register REG00. When the element a00 of the row vector a0 read from the register file RF0 is equal to the value a00 of the matrix register REG00, the encoding circuit ENC00 need not update the encoding result (0, a00, a00*2, a00*3) stored in the matrix register REG00.

The matrix register REG may store the encoding result of at least a part (for example, a row vector) of the matrix A. For example, the matrix registers REG00 to REG03 may store the encoding results (0, a00, a00*2, a00*3) to (0, a03, a03*2, a03*3) output by the encoding circuits ENC00 to ENC03.

Similarly, the matrix registers REG10 to REG33 may store the encoding results (0, a10, a10*2, a10*3) to (0, a33, a33*2, a33*3) output by the encoding circuits ENC00 to ENC03.

The multiplication circuit MUL may calculate the product of at least a part (for example, a row vector) of the matrix A and at least a part (for example, one element) of the vector B based on the encoding result read from the matrix register REG and the output of the broadcast circuit BC. For example, the multiplication circuit MUL0 may calculate the inner product c0 of the row vector a0 and the vector B by using the encoding results (0, a00, a00*2, a00*3) to (0, a03, a03*2, a03*3) read from the matrix registers REG00 to REG03 and the values b0 to b3 output from the broadcast circuit BC as inputs.

Similarly, the multiplication circuits MUL1 to MUL3 may calculate the inner products c1 to c3 of the row vectors a1 to a3 and the vector B by using the encoding results (0, a10, a10*2, a10*3) to (0, a33, a33*2, a33*3) read from the matrix registers REG10 to REG33 and the values b to b3 output from the broadcast circuit BC as inputs.

The matrix arithmetic unit MAU illustrated in FIG. 4 stores the encoding results of the matrix A in the matrix registers REG, thereby reducing the number of encoding operations when repeatedly calculating the product of the matrix A and the vector B. Therefore, the matrix arithmetic unit MAU illustrated in FIG. 4 can provide the computing device 100 that can perform matrix operations at high speed while reducing power consumption.

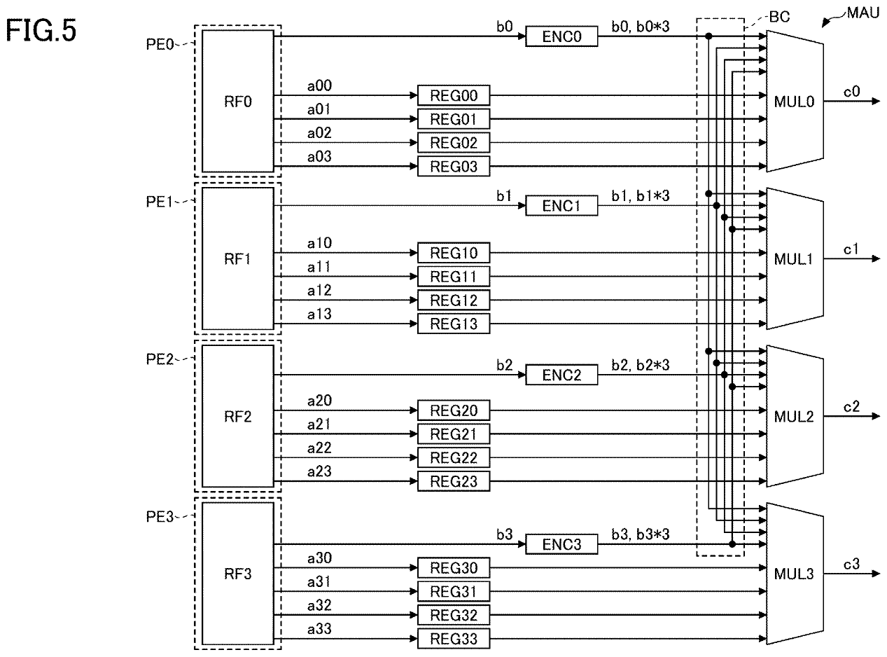

FIG. 5 is a block diagram illustrating a third example of the configuration of the matrix arithmetic unit. As illustrated in FIG. 5, the matrix arithmetic unit MAU according to the present embodiment may include 16 matrix registers REG (REG00 to REG33), four encoding circuits ENC (ENC0 to ENC3), a broadcast circuit BC, and four multiplication circuits MUL (MUL0 to MUL3).

Hereinafter, the configuration of the matrix arithmetic unit MAU illustrated in FIG. 5 will be described focusing on differences from the matrix arithmetic unit MAU illustrated in FIG. 3. Unless otherwise specified, the matrix arithmetic unit MAU illustrated in FIG. 5 may be configured in substantially the same manner as the matrix arithmetic unit MAU illustrated in FIG. 3.

The encoding circuit ENC may encode at least a portion (for example, one element) of the vector B read from the register file RF. For example, the encoding circuit ENC0 may calculate b0*3, using the value b0 read from the register file RF0. Additionally, the encoding circuit ENC0 may generate b0*2 by logically left-shifting the value b0 read from the register file RF by one bit. The encoding circuit ENC0 may input the encoded result (0, b0, b0*2, b0*3) of the value b0 into the multiplication circuit MUL0. Additionally, as illustrated in FIG. 4, a register may be provided between the encoding circuit ENC0 and the multiplication circuit MUL0. Registers may also be provided in the ENC1 to ENC3.

Similarly, the encoding circuits ENC1 to ENC3 may input the encoding results (0, b1, b1*2, b1*3) to (0, b3, b3*2, b3*3) into the broadcast circuit BC, using the values b1 to b3 read from the register files RF1 to RF3.

The broadcast circuit BC may broadcast the encoding results input by the encoding circuit ENC to the four multiplication circuits MUL0 to MUL3. For example, the broadcast circuit BC may broadcast the encoding result (0, b0, b0*2, b0*3) input by the encoding circuit ENC0 to the four multiplication circuits MUL0 to MUL3.

Similarly, the broadcast circuit BC may broadcast the encoding results (0, b1, b1*2, b1*3) to (0, b3, b3*2, b3*3) input by the encoding circuits ENC1 to ENC3 to the four multiplication circuits MUL0 to MUL3.

The multiplication circuit MUL may calculate a product of at least a part (for example, a row vector) of the matrix A and at least a part (for example, one element) of the vector B based on at least a part (for example, a row vector) of the matrix A read from the matrix register REG and the output of the broadcast circuit BC. For example, the multiplication circuit MUL0 may calculate the inner product c0 of the row vector a0 and the vector B by using the encoding results (0, b0, b0*2, b0*3) to (0, b3, b3*2, b3*3) output by the broadcast circuit BC and the values a00 to a03 read from the matrix registers REG00 to REG03 as inputs.

Similarly, the multiplication circuits MUL1 to MUL3 may calculate the inner products c1 to c3 of the row vectors a1 to a3 and the vector B by using the encoded results (0, b0, b0*2, b0*3) to (0, b3, b3*2, b3*3) output from the broadcast circuit BC and the values a10 to a33 read from the matrix registers REG10 to REG33 as inputs.

The matrix arithmetic unit MAU illustrated in FIG. 5 can reduce the number of encoding circuits by broadcasting the encoded results of the vector B to the plurality of multiplication circuits MUL0 to MUL3. For example, when the encoding circuits are mounted on each of the multiplication circuits MUL0 to MUL3, 16 encoding circuits are required, but the number of encoding circuits can be reduced to four in the matrix arithmetic unit MAU illustrated in FIG. 5. Therefore, the matrix arithmetic unit MAU illustrated in FIG. 5 can provide the computing device 100 that can perform matrix operations at high speed while reducing the circuit scale.

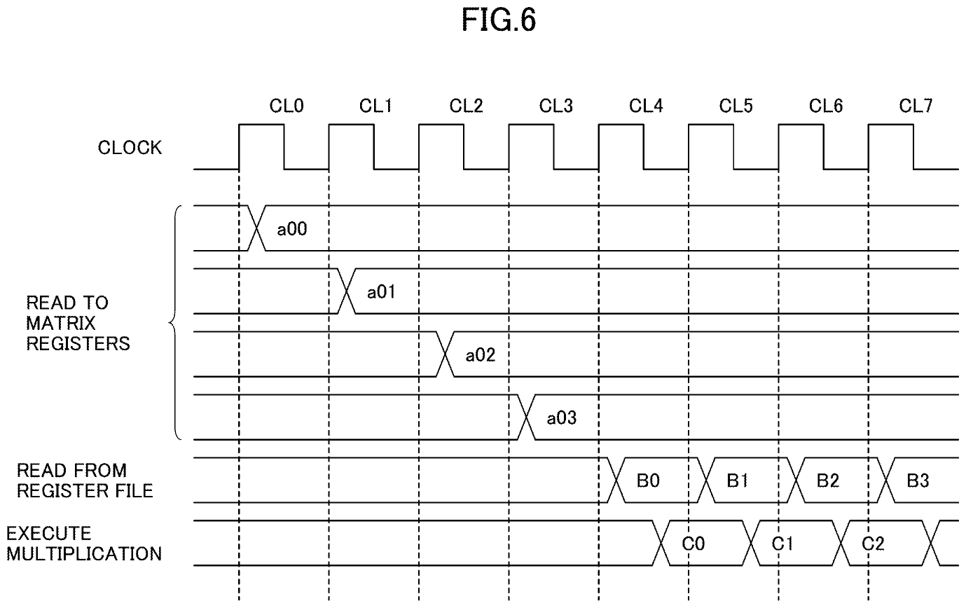

FIG. 6 is a diagram illustrating an example of the operation sequence of the matrix arithmetic unit. As illustrated in FIG. 6, the matrix arithmetic unit MAU first sequentially reads the elements a00 to a03 of the row vector a0 from the register file RF0 of the processing element PE into the matrix registers REG00 to REG03. Additionally, the encoding circuits ENC00 to ENC03 sequentially encode the elements a00 to a03 and input the encoding results into the multiplication circuit MUL0. One clock is required to read one element from the register file RF, and thus four clocks are required to read all the elements of the row vector a0 (CL0 to CL3).

Next, the matrix arithmetic unit MAU reads the vector B0 from the register files RF0 to RF3 of the processing element PE. The vector B0 may be a vector B in an initial state and may correspond to an input to a machine learning model, for example. The broadcast circuit BC broadcasts the vector B0 to the multiplication circuits MUL0 to MUL3. The multiplication circuits MUL0 to MUL3 output the product C0 of the matrix A and the vector B0. The elements b0 to b3 of the vector B0 are stored distributed among the register files RF0 to RF3, and thus one clock is required to read the vector B0 (CL4).

Subsequently, the multiplication circuits MUL0 to MUL3 store the product C0 of the matrix A and the vector B0 in the register files RF0 to RF3. Then, the vector B0 is updated to the vector B1. Thereafter, the matrix arithmetic unit MAU sequentially reads the vectors B1, B2, . . . and stores the products C1, C2, . . . with the matrix A in the register files RF0 to RF3 (CL5 and subsequent clocks). The matrix A is stored in the matrix register REG, and thus a process of reading the matrix A from the register file RF becomes unnecessary, thereby reducing the delay of the output of the product C.

### SUMMARY

As is apparent from the above description, the computing device 100 according to the embodiment of the present disclosure includes one or more register files configured to store a first matrix and a second matrix, one or more conversion circuits configured to convert a value of the first matrix or the second matrix read from the one or more register files so that the value corresponds to a plurality of values, and one or more multiplication circuits configured to calculate a product of the first matrix and the second matrix, using a result of the converting of the one or more conversion circuits.

The computing device 100 may further include one or more registers. The one or more conversion circuits may convert the first matrix read from the one or more register files and store the result of the converting in the one or more registers. The one or more conversion circuits may convert the first matrix when the first matrix stored in the one or more register files is updated, and need not convert the first matrix when the first matrix stored in the one or more register files is not updated.

The computing device 100 may further include one or more registers for storing the first matrix. The one or more conversion circuits may convert the first matrix read from the one or more registers and input the result of the converting into the one or more multiplication circuits. The computing device 100 may store the first matrix in the one or more registers when the first matrix stored in the one or more register files is updated, and need not update the first matrix stored in the one or more registers when the first matrix stored in the one or more register files is not updated.

The one or more multiplication circuits may include a plurality of multiplication circuits each configured to calculate an inner product of a vector included in the first matrix and a vector included in the second matrix. The computing device 100 may include one or more broadcast circuits configured to broadcast the second matrix to the plurality of multiplication circuits. The one or more conversion circuits may convert the second matrix read from the one or more register files, and input a result of the converting into the one or more broadcast circuits.

The one or more conversion circuits may convert the value by calculating a tripled value of the value included in the first matrix or the second matrix. The computing device 100 may select the result of the converting based on a value of a matrix, among the first matrix and the second matrix, that is not converted.

The plurality of values may include at least the value included in the first matrix or the second matrix, the tripled value of the value included in the first matrix or the second matrix, a doubled value of the value included in the first matrix or the second matrix, and 0. The doubled value of the value included in the first matrix or the second matrix may be obtained by left-shifting the value included in the first matrix or the second matrix by one bit. The selection may be performed based on two-bit information of the value of the matrix, among the first matrix and the second matrix, that is not converted.

The plurality of values may be candidates for partial products in the product of the first matrix and the second matrix. The one or more conversion circuits and the one or more multiplication circuits may be stacked on a memory die.

In one aspect, according to the embodiment of the present disclosure, when calculating the product of the first matrix and the second matrix, the first matrix or the second matrix is converted in advance, and thus the matrix operation can be performed at high speed. For example, in the present embodiment, when repeatedly calculating the product of the first matrix and the second matrix by storing the first matrix or a result of the conversion of the first matrix in the register, the number of conversions can be reduced, thereby providing a computing device that can perform the matrix operations at high speed while reducing power consumption. Additionally, for example, in the present embodiment, the number of conversion circuits can be reduced by broadcasting the result of the conversion of the second matrix to the plurality of multiplication circuits, thereby providing a computing device that can perform the matrix operation at high speed while reducing the circuit scale.

Some or all of the computing method in the above-described information processing performed by the computing device 100 may be realized by hardware or may be realized by information processing of software (program) executed by a CPU, a graphics processing unit (GPU), or the like. In the case where the information processing is realized by the information processing of software, software for realizing at least some of the functions of the information processing performed by the computing device 100 in the above-described embodiments may be stored in a non-transitory storage medium (a non-transitory computer-readable medium), such as a compact disc-read only memory (CD-ROM) or a universal serial bus (USB) memory, and a computer may read the software to perform the information processing of the software. Additionally, the software may be downloaded via a communication network. Furthermore, all or some of the processes of software may be implemented in a circuit, such as an application specific integrated circuit (ASIC) or an FPGA, and the information processing by the software may be executed by hardware.

The storage medium storing the software may be a removable medium, such as an optical disk, or a fixed storage medium, such as a hard disk or a memory. Additionally, the storage medium may be provided inside the computer (a main storage device, an auxiliary storage device, or the like) or may be provided outside the computer.

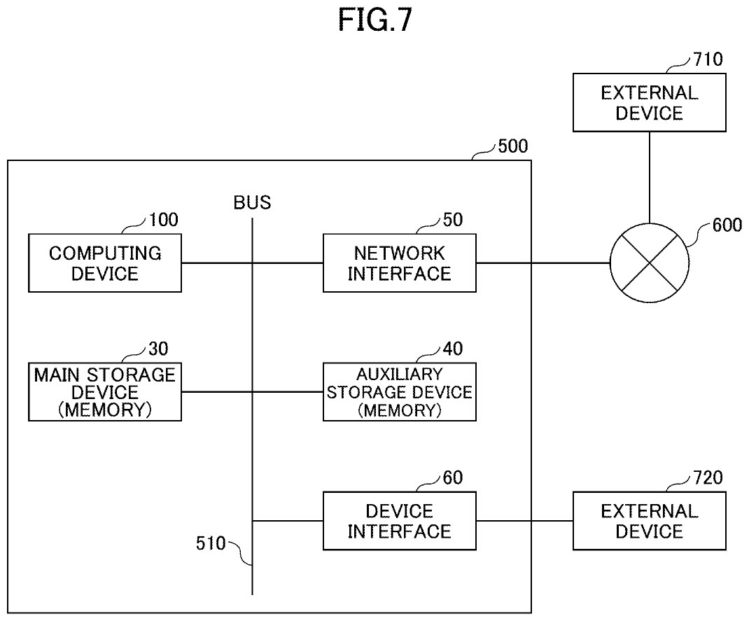

FIG. 7 is a block diagram illustrating an example of a hardware configuration of a computer in which the above-described computing device 100 is mounted. In the following description, it is assumed that the computing device 100 is mounted in the computer. In FIG. 7, for example, the computer may be realized as a computer 500 including the computing device 100, a main storage device 30 (memory), an auxiliary storage device 40 (memory), a network interface 50, and a device interface 60, which are connected via a bus 510.

The computer 500 of FIG. 7 includes one of each component, but may include multiple units of the same components. Additionally, although FIG. 7 illustrates one computer 500, the software may be installed in multiple computers, and the multiple computers may execute the same or different partial processes of the software. In this case, the computers may be in a distributed computing form in which the computers communicate with each other via the network interface 50 or the like to perform the processes. That is, a system that realizes a function by one or more computers 500 executing instructions stored in one or more storage devices may be configured. Additionally, the devices may be configured such that information transmitted from a terminal may be processed by one or more computers 500 provided on a cloud, and the processing result may be transmitted to the terminal.

The various operations may be performed by parallel processing using one or more computing devices 100 mounted in the computer 500 or using multiple computers 500 connected via a network. Additionally, various operations may be distributed to processing elements PE, which are examples of multiple operation cores in the computing device 100 and performed by parallel processing. Additionally, some or all of the processes, means, and the like of the present disclosure may be implemented by at least one of a processor or a storage device provided on a cloud that can communicate with the computer 500 via a network. As described above, the device in the above-described embodiments may be in a form of parallel computing by one or more computers.

The computing device 100 may be an electronic circuit (a processing circuit, processing circuitry, a CPU, a GPU, an FPGA, an ASIC, or the like) that performs at least one of control or operations of a computer. Additionally, the computing device 100 may be any of a dedicated processing circuit designed to execute a specific operation or a computing device including both the general-purpose processor and the dedicated processing circuit. Additionally, the computing device 100 may include an optical circuit or may include an arithmetic function based on quantum computing.

The computing device 100 may perform arithmetic processing based on data or software input from each device or the like of the internal configuration of the computer 500, and may output an arithmetic result or a control signal to each device or the like. The computing device 100 may control each component constituting the computer 500 by executing an operating system (OS), an application, or the like of the computer 500.

The inference process of the machine learning model in the above-described embodiments may be implemented by one or more computing devices 100. Here, the computing device 100 may refer to one or more electronic circuits disposed on one chip, or may refer to one or more electronic circuits disposed on two or more chips or two or more devices. When multiple electronic circuits are used, the electronic circuits may communicate with each other by wire or wirelessly.

The main storage device 30 may store instructions executed by the computing device 100, various data, and the like, and information stored in the main storage device 30 may be read by the computing device 100. The auxiliary storage device 40 is a storage device other than the main storage device 30. Here, these storage devices indicate any electronic components capable of storing electronic information, and may be semiconductor memories. The semiconductor memory may be either a volatile memory or a nonvolatile memory. The storage device for storing various data and the like in the computer 500 may be realized by the main storage device 30 or the auxiliary storage device 40, or may be realized by a built-in memory built in the computing device 100.

When the computer 500 includes at least one storage device (memory) and at least one computing device 100 connected (coupled) to the at least one storage device, the at least one computing device 100 may be connected to one storage device. Additionally, at least one storage device may be connected to one computing device 100. Additionally, a configuration in which at least one computing device 100 among the multiple computing devices 100 is connected to at least one storage device among the multiple storage devices may be included. Additionally, this configuration may be realized by storage devices and the computing devices 100 included in multiple computers 500. Furthermore, a configuration in which the storage device is integrated with the computing device 100 (e.g., an L1 cache or a cache memory including an L2 cache) may be included.

The network interface 50 is an interface for connecting to a communication network 600 by wire or wirelessly. As the network interface 50, an appropriate interface, such as one conforming to an existing communication standard, may be used. The network interface 50 may exchange information with an external device 710 connected via the communication network 600. Here, the communication network 600 may be any one of a wide area network (WAN), a local area network (LAN), a personal area network (PAN), and the like, or a combination thereof, as long as information is exchanged between the computer 500 and the external device 710. Examples of the WAN include the Internet and the like, and examples of the LAN include IEEE802.11, Ethernet (registered trademark), and the like. Examples of the PAN include Bluetooth (registered trademark), Near Field Communication (NFC), and the like.

The device interface 60 is an interface, such as a USB, that is directly connected to an external device 720.

The external device 710 is a device connected to the computer 500 via a network. The external device 720 is a device directly connected to the computer 500.

The external device 710 or the external device 720 may be, for example, an input device. The input device is, for example, a device, such as a camera, a microphone, a motion capture device, various sensors, a keyboard, a mouse, a touch panel, or the like, and gives acquired information to the computer 500. Alternatively, the device may be a device including an input unit, a memory, and a processor, such as a personal computer, a tablet terminal, or a smartphone.

Additionally, the external device 710 or the external device 720 may be, for example, an output device. The output device may be, for example, a display device, such as a liquid crystal display (LCD) or an organic electro luminescence (EL) panel, or may be a speaker that outputs sound or the like. Alternatively, the device may be a device including an output unit, a memory, and a processor, such as a personal computer, a tablet terminal, or a smartphone.

Additionally, the external device 710 or the external device 720 may be a storage device (a memory). For example, the external device 710 may be a network storage or the like, and the external device 720 may be a storage, such as a hard disk drive (HDD).

Additionally, the external device 710 or the external device 720 may be a device having a function of a part of the components of the computer 500. That is, the computer 500 may transmit a part or all of the processing result to the external device 710 or the external device 720, or may receive a part or all of the processing result from the external device 710 or the external device 720.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “using data”, “based on data”, “according to data”, or “in accordance with data” (including similar expressions) is used, unless otherwise noted, a case in which the data itself is used and a case in which data obtained by processing the data (e.g., data obtained by adding noise, normalized data, a feature amount extracted from the data, and intermediate representation of the data) is used are included. If it is described that any result can be obtained “in response to data being input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states may be included. If it is described that “data is output” (including similar expressions), unless otherwise noted, a case in which the data itself is used as an output is included, and a case in which data obtained by processing the data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, and/or states, and that the advantage/result is not necessarily obtained by the configuration. The advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), when a term such as “maximize/maximization” is used, it includes finding a global maximum value, finding an approximate value of a global maximum value, finding a local maximum value, and finding an approximate value of a local maximum value, and should be interpreted appropriately depending on the context in which the term is used. Additionally, it includes probabilistically or heuristically finding an approximate value of these maximum values. Similarly, when a term such as “minimize/minimization” is used, it includes finding a global minimum value, finding an approximate value of a global minimum value, finding a local minimum value, and finding an approximate value of a local minimum value, and should be interpreted appropriately depending on the context in which the term is used. Additionally, it includes probabilistically or heuristically finding an approximate value of these minimum values. Similarly, when a term such as “optimize/optimization” is used, it includes finding a global optimum value, finding an approximate value of a global optimum value, finding a local optimum value, and finding an approximate value of a local optimum value, and should be interpreted appropriately depending on the context in which the term is used. Additionally, it includes probabilistically or heuristically finding an approximate value of these optimum values.

In the present specification (including the claims), if multiple pieces of hardware perform predetermined processes, each of the pieces of hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more pieces of hardware perform a process A and the one or more pieces of hardware perform a process B” is used, the hardware that performs the process A may be the same as or different from the hardware that performs the process B. That is, the hardware that performs the process A and the hardware that performs the process B may be included in the one or more pieces of hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data. Additionally, a configuration in which some of the multiple storage devices store data may be included.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in the embodiments described above, if numerical values or mathematical expressions are used for description, they are presented as an example and do not limit the scope of the present disclosure. Additionally, the order of respective operations in the embodiments is presented as an example and does not limit the scope of the present disclosure.

It should be noted that the disclosed technology may take the form of the following clauses.

### (Clause 1)

A computing device including:
one or more register files configured to store a first matrix and a second matrix;
one or more conversion circuits configured to convert a value of the first matrix or the second matrix read from the one or more register files so that the value corresponds to a plurality of values; and
one or more multiplication circuits configured to calculate a product of the first matrix and the second matrix, using a result of the converting of the one or more conversion circuits.

### (Clause 2)

The computing device as described in Clause 1, further including one or more registers,
wherein the one or more conversion circuits convert the first matrix read from the one or more register files and store the result of the converting in the one or more registers.

### (Clause 3)

The computing device as described in Clause 2,
wherein the one or more conversion circuits convert the first matrix when the first matrix stored in the one or more register files is updated, and do not convert the first matrix when the first matrix stored in the one or more register files is not updated.

### (Clause 4)

The computing device as described in any one of Clauses 1 to 3, further including one or more registers configured to store the first matrix,
wherein the one or more conversion circuits convert the first matrix read from the one or more registers, and input the result of the converting into the one or more multiplication circuits.

### (Clause 5)

The computing device as described in Clause 4,
wherein the first matrix is stored in the one or more registers when the first matrix stored in the one or more register files is updated, and
wherein the first matrix stored in the one or more registers is not updated when the first matrix stored in the one or more register files is not updated.

### (Clause 6)

The computing device as described in any one of Clauses 1 to 5,
wherein the one or more multiplication circuits include:
   a plurality of multiplication circuits each configured to calculate an inner product of a vector included in the first matrix and a vector included in the second matrix; and
   one or more broadcast circuits configured to broadcast the second matrix to the plurality of multiplication circuits, and
wherein the one or more conversion circuits convert the second matrix read from the one or more register files, and input a result of the converting into the one or more broadcast circuits.

### (Clause 7)

The computing device as described in any one of Clauses 1 to 6, wherein the one or more conversion circuits convert the value by calculating a tripled value of the value included in the first matrix or the second matrix.

### (Clause 8)

The computing device as described in any one of Clauses 1 to 7, wherein the result of the converting is selected based on a value of a matrix, among the first matrix and the second matrix, that is not converted.

### (Clause 9)

The computing device as described in Clause 8, wherein the plurality of values include at least the value included in the first matrix or the second matrix, a tripled value of the value included in the first matrix or the second matrix, a doubled value of the value included in the first matrix or the second matrix, and 0.

### (Clause 10)

The computing device as described in Clause 9, wherein the doubled value of the value included in the first matrix or the second matrix is obtained by left-shifting the value included in the first matrix or the second matrix by one bit.

### (Clause 11)

The computing device as described in any one of Clauses 8 to 10, wherein the selection is performed based on information for each two bits of the value of the matrix, among the first matrix and the second matrix, that is not converted.

### (Clause 12)

The computing device as described in any one of Clauses 1 to 11, wherein the plurality of values are candidates for partial products in the product of the first matrix and the second matrix.

### (Clause 13)

The computing device as described in any one of Clauses 1 to 12, wherein the one or more conversion circuits and the one or more multiplication circuits are stacked on a memory die.

1. A computing device comprising:
one or more register files configured to store a first matrix and a second matrix;
one or more conversion circuits configured to convert a value of the first matrix or the second matrix read from the one or more register files so that the value corresponds to a plurality of values; and
one or more multiplication circuits configured to calculate a product of the first matrix and the second matrix, using a result of the converting of the one or more conversion circuits.

2. The computing device as claimed in claim 1, further comprising one or more registers,
wherein the one or more conversion circuits convert the first matrix read from the one or more register files and store the result of the converting in the one or more registers.

3. The computing device as claimed in claim 2,
wherein the one or more conversion circuits convert the first matrix when the first matrix stored in the one or more register files is updated, and do not convert the first matrix when the first matrix stored in the one or more register files is not updated.

4. The computing device as claimed in claim 1, further comprising one or more registers configured to store the first matrix,
wherein the one or more conversion circuits convert the first matrix read from the one or more registers, and input the result of the converting into the one or more multiplication circuits.

5. The computing device as claimed in claim 4,
wherein the first matrix is stored in the one or more registers when the first matrix stored in the one or more register files is updated, and
wherein the first matrix stored in the one or more registers is not updated when the first matrix stored in the one or more register files is not updated.

6. The computing device as claimed in claim 1,
wherein the one or more multiplication circuits include:
a plurality of multiplication circuits each configured to calculate an inner product of a vector included in the first matrix and a vector included in the second matrix; and
one or more broadcast circuits configured to broadcast the second matrix to the plurality of multiplication circuits, and
wherein the one or more conversion circuits convert the second matrix read from the one or more register files, and input a result of the converting into the one or more broadcast circuits.

7. The computing device as claimed in claim 1, wherein the one or more conversion circuits convert the value by calculating a tripled value of the value included in the first matrix or the second matrix.

8. The computing device as claimed in claim 1, wherein the result of the converting is selected based on a value of a matrix, among the first matrix and the second matrix, that is not converted.

9. The computing device as claimed in claim 8, wherein the plurality of values include at least the value included in the first matrix or the second matrix, a tripled value of the value included in the first matrix or the second matrix, a doubled value of the value included in the first matrix or the second matrix, and 0.

10. The computing device as claimed in claim 9, wherein the doubled value of the value included in the first matrix or the second matrix is obtained by left-shifting the value included in the first matrix or the second matrix by one bit.

11. The computing device as claimed in claim 8, wherein the selection is performed based on information for each two bits of the value of the matrix, among the first matrix and the second matrix, that is not converted.

12. The computing device as claimed in claim 1, wherein the plurality of values are candidates for partial products in the product of the first matrix and the second matrix.

13. The computing device as claimed in claim 1, wherein the one or more conversion circuits and the one or more multiplication circuits are stacked on a memory die.

14. A computing method of a computing device including one or more register files configured to store a first matrix and a second matrix, one or more conversion circuits, and one or more multiplication circuits, the computing method comprising:
converting, by the one or more conversion circuits, a value of the first matrix or the second matrix read from the one or more register files so that the value corresponds to a plurality of values, and
calculating, by the one or more multiplication circuits, a product of the first matrix and the second matrix, using a result of the converting of the one or more conversion circuits.

15. The computing method as claimed in claim 14,
wherein the computing device further includes one or more registers, and
wherein the converting includes converting the first matrix read from the one or more register files and storing the result of the converting in the one or more registers.

16. The computing method as claimed in claim 15, wherein the converting includes converting the first matrix when the first matrix stored in the one or more register files is updated, and not converting the first matrix when the first matrix stored in the one or more register files is not updated.

17. The computing method as claimed in claim 14,
wherein the computing device further includes one or more registers configured to store the first matrix, and
wherein the converting includes converting the first matrix read from the one or more registers, and inputting the result of the converting into the one or more multiplication circuits.

18. The computing method as claimed in claim 17, wherein the converting includes storing the first matrix in the one or more registers when the first matrix stored in the one or more register files is updated, and not updating the first matrix stored in the one or more registers when the first matrix stored in the one or more register files is not updated.

19. The computing method as claimed in claim 14,
wherein the one or more multiplication circuits include:
a plurality of multiplication circuits each configured to calculate an inner product of a vector included in the first matrix and a vector included in the second matrix; and
one or more broadcast circuits configured to broadcast the second matrix to the plurality of multiplication circuits, and
wherein the converting includes converting the second matrix read from the one or more register files and inputting a result of the converting into the one or more broadcast circuits.

20. The computing method as claimed in claim 14, wherein the converting includes converting the value by calculating a tripled value of the value included in the first matrix or the second matrix.
